(19) United States
(12) Patent Application Publication
(10) Pub. No.: US 2019/0249075 A1
(43) Pub. Date: Aug. 15, 2019

(54) PROCESS OF RECOVERING OIL

(71) Applicant: SHELL OIL COMPANY, HOUSTON, TX (US)

(72) Inventors: Gerardus GLASBERGEN, Rijswijk (NL); Mark Theodoor LOOIJER, Rijswijk (NL)

(21) Appl. No.: 16/338,548

(22) PCT Filed: Sep. 28, 2017
(86) PCT No.: PCT/EP2017/074604

§ 371 Date: Apr. 1, 2019

Related U.S. Application Data
(60) Provisional application No. 62/403,458, filed on Oct. 3, 2016.

(51) Int. Cl. C09K 8/588; B01D 17/04; E21B 43/20; E21B 43/40; E21B 43/01

(52) U.S. Cl. CPC C09K 8/588; B01D 17/047; E21B 43/01; E21B 43/40; E21B 43/20

(57) ABSTRACT

A process of recovering oil from an oil-bearing formation which process comprises injecting into the formation an aqueous enhanced oil recovery formulation comprising water and an enhanced oil recovery additive, which process comprises supplying water via a first conduit to a flow control valve, combining water which has passed the flow control device with an additive solution containing at least 3000 ppm of the enhanced oil recovery additive to obtain the aqueous enhanced oil recovery formulation, injecting the aqueous enhanced oil recovery formulation into the formation via a first well, producing from the formation via a second well a mixture and separating oil from the mixture produced.

### FIELD OF THE INVENTION

The present invention relates to a process of recovering oil from an oil-bearing formation.

### BACKGROUND OF THE INVENTION

In the recovery of oil from a subterranean formation, only a portion of the oil in the formation generally is recovered using primary recovery methods utilizing the natural formation pressure to produce the oil. A portion of the oil that cannot be produced from the formation using primary recovery methods may be produced by chemical enhanced oil recovery, also referred to as improved oil recovery or EOR.

Enhanced oil recovery can utilize aqueous solutions comprising enhanced oil recovery additives such as surfactant, polymer or a combination of surfactant and polymer to flood an oil-bearing formation to increase the amount of oil recovered from the formation. An aqueous solution of enhanced oil recovery additive is injected into an oil-bearing formation to increase recovery of oil from the formation, either after primary recovery or after a secondary recovery water flood. Without wishing to be bound by any theory, it is thought that enhanced oil recovery surfactant increases recovery of oil by lowering interfacial tension between oil and water phases in the formation thereby mobilizing the oil for production. Enhanced oil recovery polymer is thought to increase the viscosity of the enhanced oil recovery formulation, which can be to the same order of magnitude as the oil in the formation in order to force the mobilized oil through the formation for production by the polymer containing flood.

Enhanced oil recovery additive containing formulations tend to be injected into the oil-bearing formation via multiple conduits each containing a flow control device to ensure that flow of the enhanced oil recovery formulation from the conduit into the formation can be controlled. A disadvantage of flow control devices is that these are thought to contribute in many instances to the degradation of the enhanced oil recovery additive. This can cause a substantial viscosity reduction which in some cases was observed to be as high as 80%. Without wishing to be bound by any theory, it is thought that the degradation of the additive in the flow control device is due to mechanical degradation caused by high flow shear rate.

An option would be to replace conventional flow control devices by devices which have been developed with the special aim of reducing the shear experienced by the additive. However, such so-called low-shear flow control valves tend to be complex and not yet fully proven from a reliability, fouling and abrasion point of view.

### SUMMARY OF THE INVENTION

We have found an enhanced oil recovery process and system which can reduce shear exerted on enhanced oil recovery additive while still allowing control of flow with the help of a conventional flow control device.

The present process of recovering oil from an oil-bearing formation comprises injecting into the formation an aqueous enhanced oil recovery formulation comprising water and an enhanced oil recovery additive and comprises (i) supplying water via a first conduit to a flow control valve, (ii) combining water which has passed the flow control device with an additive solution containing at least 3000 ppm of the enhanced oil recovery additive to obtain the aqueous enhanced oil recovery formulation, (iii) injecting the aqueous enhanced oil recovery formulation into the formation via a first well, (iv) producing from the formation via a second well a mixture comprising water and oil, and (v) separating oil from the mixture produced.

The present system for recovering oil from an oil-bearing formation comprises (a) a first conduit for supplying water to a flow control device which first conduit is in fluid communication with the high pressure side of the flow control device, (b) a flow control device, (c) a second conduit which is in fluid communication with the low pressure side of the flow control device and with a first well which first well is in fluid communication with the second conduit and the formation, (d) a third conduit for supplying an additive solution containing at least 3000 ppm of enhanced oil recovery additive which third conduit is in fluid communication with an additive solution supply such as a container containing additive solution and the second conduit, (e) a second well which is in fluid communication with the formation and a container for collecting the mixture comprising water and oil from the formation, and (f) a means for separating oil from the mixture comprising water and oil obtained from the formation.

### BRIEF DESCRIPTION OF THE DRAWING

FIG. 1 is a diagram of a process and system for enhanced oil recovery not according to the invention. Aqueous enhanced oil recovery formulation is prepared and subsequently passed through a flow control device.

FIG. 2 is a diagram of a process and system for enhanced oil recovery illustrating the invention. Water for preparing the enhanced oil recovery formulation is passed through the flow control device before being mixed with the additive solution to form the aqueous enhanced oil recovery formulation.

### DETAILED DESCRIPTION OF THE INVENTION

The present process and system are for recovering oil from an oil-bearing formation. As an oil-bearing formation can additionally contain gas, the process and system can recover gas besides oil. In such cases, gas will be recovered together with oil from the mixture produced from the formation or the gas and oil will each be recovered separately. The process and system may solely recover oil.

The expression water is used to indicate any source of water including but not limited to pure water, fresh water generally containing traces of contaminants up to sea water and brine containing substantial amounts of such contaminants.

Pure water is water having a total dissolved solids content (TDS, measured according to ASTM D5907) of at most 4000 ppm, more specifically at most 3000 ppm, more specifically at most 2000 ppm, most specifically at most 1000 ppm. The expression “ppm” indicates parts per million by weight on total weight amount present.

Water sources other than pure water are sea water, brackish water, aquifer water, formation water and brine. Sources other than fresh water generally have a TDS of more than 1,000 ppm, more specifically at least 2,000 ppm, more specifically at least 3,000 ppm, more specifically at least 4,000 ppm, more specifically at least 5,000 ppm, most specifically at least 10,000 ppm. Most water sources have a TDS of less than 100,000 ppm, more specifically a TDS of less than 80,000 ppm, more specifically at most 60,000 ppm, most specifically at most 40,000 ppm. These amounts are before any enhanced oil recovery additive has been added.

It is especially advantageous if the water contains a limited amount of divalent ions such as less than 4000 ppm, more specifically less than 2000 ppm, more specifically less than 1000 ppm, more specifically at most 500 ppm, more specifically at most 100 ppm, most specifically at most 20 ppm of divalent ions based on total amount of water. More specifically, these amounts relate to the calcium and/or magnesium ions present.

The enhanced oil recovery additive can be selected from the group consisting of enhanced oil recovery polymer, enhanced oil recovery surfactant and a mixture thereof. It can be advantageous that the additive is enhanced oil recovery polymer.

The additive solution can comprise at least 3,000 ppm of additive, more especially at least 4,000 ppm, more especially at least 5,000 ppm of enhanced oil recovery additive. The additive solution can comprise at most 300,000 ppm, more especially at most 200,000 ppm, more specifically at most 150,000 ppm, more specifically at most 100,000 ppm of enhanced oil recovery additive. These amounts are the combined amounts of all enhanced oil recovery additives in the additive solution.

The additive solution can comprise at most 10 percent by weight (% wt) of polymer, more specifically at most 8% wt of polymer, more specifically at most 5% wt of polymer, more specifically at most 4% wt of polymer, more specifically at most 3% wt of polymer, more specifically at most 2% wt of polymer. The amount of polymer can be at least 0.02% wt, more specifically at least 0.05% wt, more specifically at least 0.1% wt, more specifically at least 0.2% wt, more specifically at least 0.5% wt.

If the additive solution comprises an emulsion of enhanced oil recovery polymer, it can be advantageous that the solution additionally contains surfactant. The amount of surfactant present in an additive solution comprising an emulsion of enhanced oil recovery polymer can be at least 1% wt, more specifically at least 2% wt, more specifically at least 5% wt of surfactant based on total amount of enhanced oil recovery polymer. The amount of surfactant can be at most 50% wt, more specifically at most 40% wt, more specifically at most 30% wt of surfactant based on total amount of enhanced oil recovery polymer.

The concentration of additive in the aqueous enhanced oil recovery formulation can be substantially lower than the additive concentration in the additive solution. The concentration of enhanced oil recovery additive in the aqueous enhanced oil recovery formulation may be at most 60% of the additive concentration in the additive solution, more specifically at most 50%, more specifically at most 40%, more specifically at most 30%, more specifically at most 20% of the additive concentration in the additive solution. The percentage is based on weight amount of all enhanced oil recovery additives. The additive concentration of the additive in the aqueous enhanced oil recovery formulation can be at least 0.1% and more specifically at least 1% of the additive concentration in the additive solution.

The enhanced oil recovery surfactant may be any surfactant effective to reduce the interfacial tension between oil and water in the oil-bearing formation and thereby mobilize the oil for production from the formation. The oil recovery formulation may comprise one or more surfactants. The surfactant may be an anionic surfactant. The anionic surfactant may be a sulfonate-containing compound, a sulfate-containing compound, a carboxylate compound, a phosphate compound, or a blend thereof. The anionic surfactant may be an alpha olefin sulfonate compound, an internal olefin sulfonate compound, a branched alkyl benzene sulfonate compound, a propylene oxide sulfate compound, an ethylene oxide sulfate compound, a propylene oxide-ethylene oxide sulfate compound, or a blend thereof.

The anionic surfactant can contain from 12 to 28 carbons, or from 12 to 20 carbons. The surfactant of the oil recovery formulation may comprise an internal olefin sulfonate compound containing from 15 to 18 carbons or a propylene oxide sulfate compound containing from 12 to 15 carbons, or a blend thereof, where the blend contains a volume ratio of the propylene oxide sulfate to the internal olefin sulfonate compound of from 1:1 to 10:1.

The aqueous enhanced oil recovery formulation which is injected into the formation may contain an amount of the surfactant effective to reduce the interfacial tension between oil and water in the formation and thereby mobilize the oil for production from the formation. This aqueous enhanced oil recovery formulation may contain from 0.05% wt to 10% wt of total amount of surfactant or combination of surfactants based on total amount of aqueous enhanced oil recovery formulation. It can be advantageous that the enhanced oil recovery formulation contains at least 0.2% wt of surfactant. The aqueous enhanced oil recovery formulation may contain at most 5% wt of surfactant, more specifically at most 3% wt of surfactant, more specifically at most 2% wt of surfactant or combination of surfactants.

The additive also can be polymer. Polymer generally is intended to provide the formulation with a viscosity of the same order of magnitude as the viscosity of oil in the formation under formation temperature conditions so the aqueous enhanced oil recovery formulation may drive mobilized oil across the formation for production from the formation with a minimum of fingering of the oil through the aqueous enhanced oil recovery formulation and/or fingering of the aqueous enhanced oil recovery formulation through the oil. The polymer can be a single compound or can be a mixture of compounds. The polymer can be selected from the group consisting of polyacrylamide; partially hydrolyzed polyacrylamide; polyacrylate; ethylenic copolymer; carboxymethylcelloluse; polyvinyl alcohol; polystyrene sulfonate; polyvinylpyrrolidone; biopolymers; copolymer of acrylamide and 2-acrylamido-2-methylpropanesulfonic acid (ATBS); terpolymer of ATBS, acrylic acid and acrylamide; styrene-acrylate copolymer; copolymers of acrylamide, acrylic acid, ATBS and n-vinylpyrrolidone; and combinations thereof. The copolymers and terpolymers can contain the various monomers in any ratio.

Examples of ethylenic copolymers include copolymers of acrylic acid and acrylamide, acrylic acid and lauryl acrylate, and lauryl acrylate and acrylamide. Examples of biopolymers include xanthan gum, guar gum, schizophyllan and scleroglucan.

More specifically, the polymer is selected from the group consisting of partially hydrolyzed polyacrylamide, copolymer of acrylamide and acrylate, copolymer of acrylamide and acrylamido tertiary butyl sulfonate, terpolymer of acrylamide, acrylate and acrylamido tertiary butyl sulfonate and mixtures thereof. In these cases, the copolymer or terpolymer can be prepared from acrylate or acrylic acid. The acrylate can be any acrylate including but not limited to sodium acrylate. Polymers which can be used are commercially available from the company SNF such as partially hydrolyzed polyacrylamide sold under the name Flopaam 3630S, copolymer of acrylamide and acrylate sold under the name Flopaam 6030S and polyacrylamide sold under the name Flopaam EM533.

The concentration of the polymer in the aqueous enhanced oil recovery formulation to be injected into the formation can be sufficient to provide the oil recovery formulation with a dynamic viscosity of at least 0.3 mPa s (0.3 cP), more specifically at least 1 mPa s (1 cP), or at least 10 mPa s (10 cP), or at least 100 mPa s (100 cP), or at least 1000 mPa s (1000 cP) at 25° C. or at a temperature within a formation temperature range. The concentration of polymer in the aqueous enhanced oil recovery formulation can be from 250 ppm to 10000 ppm, more specifically of from 500 ppm to 5000 ppm, more specifically of from 1000 to 2000 ppm based on total amount of formulation.

The molecular weight number average of the polymer in the oil recovery formulation can be at least 10000 daltons, or at least 50000 daltons, or at least 100,000 daltons. The polymer can have a molecular weight number average of from 10,000 to 30,000,000 daltons, or from 100,000 to 15,000,000 daltons.

The aqueous enhanced oil recovery formulation may also comprise a co-solvent besides water, where the co-solvent may be a low molecular weight alcohol including, but not limited to, methanol, ethanol, and iso-propanol, isobutyl alcohol, secondary butyl alcohol, n-butyl alcohol, t-butyl alcohol, or a glycol including, but not limited to, ethylene glycol, 1,3-propanediol, 1,2-propandiol, diethylene glycol butyl ether, triethylene glycol butyl ether, or a sulfosuccinate including, but not limited to, sodium dihexyl sulfosuccinate. The co-solvent may be utilized for assisting in prevention of formation of a viscous emulsion. If present, the co-solvent can be present in an amount of from 100 ppm to 50,000 ppm, or from 500 ppm to 5,000 ppm of the total oil recovery formulation. A co-solvent may be absent from the oil recovery formulation. The co-solvent can be added as part of the water or as part of the additive solution.

The oil recovery formulation may additionally contain paraffin inhibitor to inhibit the formation of a viscous paraffin-containing emulsion in the mobilized oil by inhibiting the agglomeration of paraffins in the oil. The mobilized oil, therefore, may flow more freely through the formation for production relative to mobilized oil in which paraffins enhance the formation of viscous emulsions. The paraffin inhibitor of the oil recovery formulation may be a compound effective to inhibit or suppress formation of a paraffin-containing emulsion. The paraffin inhibitor may be a compound effective to inhibit or suppress agglomeration of paraffins to inhibit or suppress paraffinic wax crystal growth in the oil of the formation upon contact of the oil recovery formulation with the oil in the formation. The paraffin inhibitor may be any commercially available conventional crude oil pour point depressant or flow improver that is dispersible, and can be soluble, in the fluid of the oil recovery formulation in the presence of the other components of the oil recovery formulation, and that is effective to inhibit or suppress formation of a paraffin-nucleated emulsion in the oil of the formation. The paraffin inhibitor may be selected from the group consisting of alkyl acrylate copolymers, alkyl methacrylate copolymers, alkyl acrylate vinylpyridine copolymers, ethylene vinylacetate copolymers, maleic anhydride ester copolymers, styrene anhydride ester copolymers, branched polyethylenes, and combinations thereof. The paraffin inhibitor can be added as part of the water or as part of the additive solution. It can be advantageous if the paraffin inhibitor is present in the additive solution.

Commercially available paraffin inhibitors that may be used in the oil recovery formulation include HiTEC 5714, HiTEC 5788, and HiTEC 672 available from Afton Chemical Corp; FLOTRON D1330 available from Champion Technologies; and INFINEUM V300 series available from Infineum International.

The paraffin inhibitor may be present in the aqueous enhanced oil recovery formulation in an amount of from 5 ppm to 5,000 ppm, or from 10 ppm to 1,000 ppm, or from 15 ppm to 500 ppm, or from 20 ppm to 300 ppm based on total amount of formulation.

The aqueous enhanced oil recovery formulation can further contain alkali. Alkali may not only aid in dissolving the polymer but may also interact with oil in the formation to form a soap effective to reduce the interfacial tension between oil and water in the formation. The alkali can be selected from the group consisting of ammonia, lithium hydroxide, sodium hydroxide, potassium hydroxide, lithium carbonate, sodium carbonate, potassium carbonate, lithium bicarbonate, sodium bicarbonate, potassium bicarbonate, lithium silicate, sodium silicate, potassium silicate, lithium phosphate, sodium phosphate, potassium phosphate, and mixtures thereof. It can be especially advantageous if the alkali is ammonia. If alkali is to be added, the alkali may be added as part of the additive solution.

The amount of the alkali effective to interact with the oil in the formation to form a soap effective to reduce the interfacial tension between oil and water in the formation and thereby mobilize the oil for production from the formation can be of from 0.001% wt to 5% wt of the alkali, or from 0.005% wt to 1% wt of the alkali, or from 0.01% wt to 0.5% wt of the alkali based on total amount of enhanced oil recovery formulation.

The flow control device can be any device which is known to the person skilled in the art to be suitable for regulating the flow of fluid for injecting the fluid into an oil-bearing formation. Such device can also be referred to as choke or control valve. The device tends to contain a valve for reducing the pressure of the fluid. Typically, the pressure drop over the flow control device can range from 0 (valve wide open) to 100 bar. A suitable device has been described in U.S. Pat. No. 4,825,895. A further suitable device has been described in US2012/0205098 assigned to TEC Artec Valves. Further suitable devices are commercially available such as choke 100-DPC and choke 860HPC available from IMI critical engineering or MOV chokes available from Cameron or water injection chokes available from Flowserve and SNF.

The additive solution can be mixed with the water to obtain the aqueous enhanced oil recovery formulation by adding the additive solution with sufficient pressure difference to the water flowing through a conduit which is in fluid communication with the reduced or low pressure side of the flow control device and the formation via the first well.

The additive solution can be supplied from an additive storage via a main conduit connected to multiple further conduits each of which further conduits contains a flow control device. The latter hereinafter is referred to as additive flow control device to distinguish it from the flow control device for controlling the flow of water. The additive flow control device can be any flow device known to be suitable to the skilled person. The flow control devices mentioned above to be suitable for controlling the flow of water, also tend to be suitable for controlling the flow of additive solution. The further conduit can be connected to the high pressure side of the additive flow control device. A conduit for supplying an additive solution to the water may be in fluid communication with the low pressure side of the additive flow control device and the conduit containing the water which has passed the device controlling the flow of water.

Alternatively, the additive solution can be supplied via multiple conduits each containing an additive flow control device wherein water is added upstream of the additive flow control device and additive is added downstream of the additive flow control. The additive can be added as a fluid having a high concentration of additive. The additive fluid can have an additive concentration which is at least twice (2 times) the additive concentration of the additive solution, more specifically at least 4 times this concentration. The additive fluid can contain at least 10% wt of enhanced oil recovery additive, more specifically more than 10% wt of enhanced oil recovery additive, more specifically at least 15% wt of enhanced oil recovery additive. Mixing of the water and additive fluid produces the additive solution. This embodiment has the advantage that the additive does not have to pass a flow control device and thus is not subjected to the shear exerted therein.

Generally, the equipment for enhanced oil recovery from an oil-bearing formation below a body of water is located on a single vessel. An embodiment of the present invention comprises a process in which a vessel contains the equipment for injecting water into the formation and receiving the mixture produced from the formation while a further vessel contains the equipment for storing and adding the additive solution. This embodiment allows the further vessel to move to a different formation when polymer addition is no longer required at the original formation.

The oil contained in the oil-bearing formation may have a dynamic viscosity under formation conditions (in particular, at temperatures within the temperature range of the formation) of at least 0.3 mPa s (0.3 cP), more specifically at least 1 mPa s (1 cP), or at least 10 mPa s (10 cP), or at least 100 mPa s (100 cP), or at least 1000 mPa s (1000 cP), or at least 10000 mPa s (10000 cP). The oil contained in the oil-bearing formation may have a dynamic viscosity under formation temperature conditions of from 1 to 10000000 mPa s (1 to 10000000 cP).

These and other features, embodiments and advantages are hereinafter described in relation with the accompanying drawings.

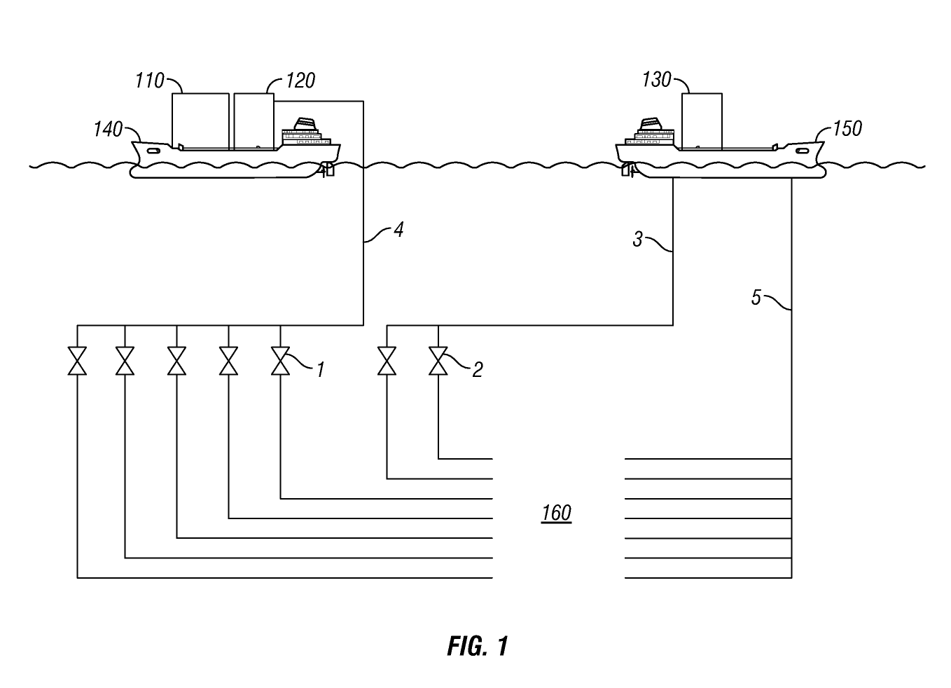

FIG. 1 shows a process and system not according to the present invention. This process and system involve an oil containing underground formation 160, which is located underneath a body of water. Enhanced oil recovery formulation is prepared from additive solution present in storage tank 110 which is diluted for example with sea water, to obtain enhanced oil recovery formulation which is subsequently stored in unit 120. The enhanced oil recovery formulation subsequently flows via conduit 4 to flow control device 1. Storage tank 110 and unit 120 are located on a vessel 140 floating on water. Separately, water can be injected into the formation 160 by pressurizing water in unit 130 located on vessel 150 and injecting the water via conduit 3 and flow control device 2. It will be clear that many conduits and flow control devices are required in order to inject either water per se or enhanced oil recovery formulation into the formation. It is advantageous to be able to inject either of these fluids in case additive is not required for that part of the formation at the time in question. A mixture of water, oil and optionally gas can be recovered from the formation via conduit 5.

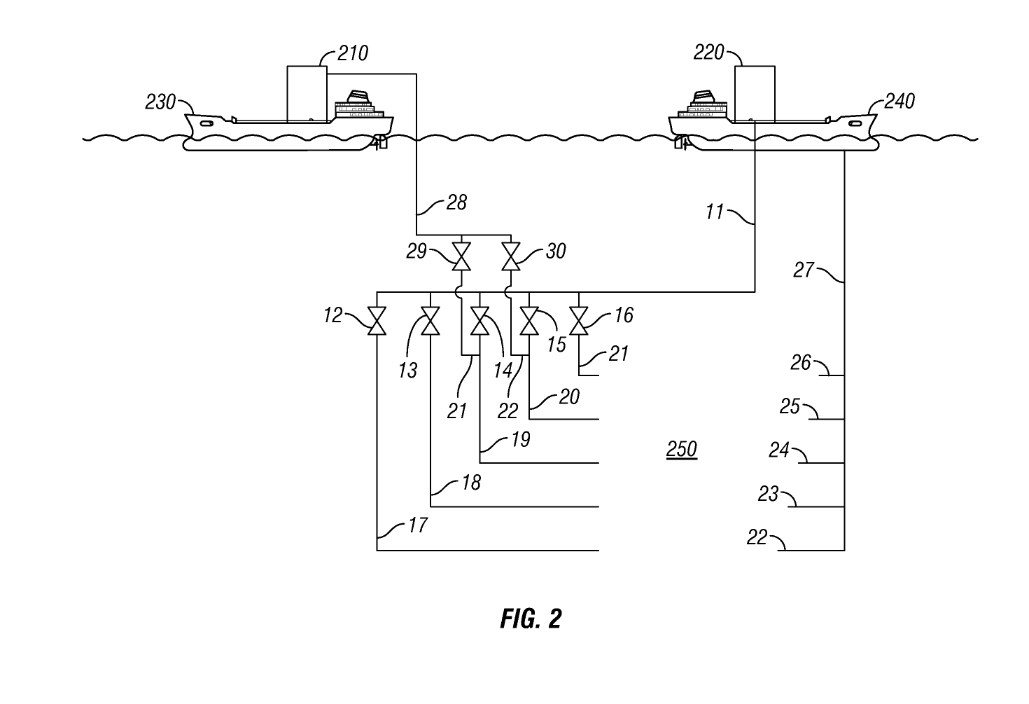

FIG. 2 shows oil containing underground formation 250, which is located underneath a body of water. Additive solution is present in storage tank 210 located on a vessel 230 floating on water. Alternatively, storage tank 210 can contain highly concentrated additive fluid which is diluted with sea water to obtain additive solution which is introduced into conduit 28. Dilution of additive fluid to obtain additive solution can vary widely and can be a weight ratio of highly concentrated additive fluid to sea water of 1 part of additive fluid to of from 10 to 300 of sea water. Additive solution flows via main conduit 28 which is in fluid communication with further conduits 21 and 22 via additive flow control devices 29 and 30. The additive solution is combined via conduits 21 and 22 with water flowing from the low pressure side of flow control devices 14 and 15. Although only a limited number of conduits and flow control devices are shown, it will be clear that this number can vary widely depending on the number of enhanced oil recovery injection points required. A separate system (not shown) can tailor the concentration of the enhanced oil recovery formulation injected at each point by distributing the additive solution over the various conduits. This system can also be used to allow for injection of other chemicals for example to damaged wells while the water flooding of the formation can be continued. Separately, water can be injected into the formation 250 by pressurizing water in unit 220 located on vessel 240 and injecting the water via main conduit 11, flow valves 12, 13 and 16 and further conduits 17, 18 and 21. A separate device for controlling the flow of the additive solution has been observed to reduce the mechanical degradation of the additive. Without wishing to be bound to any theory, it is thought that high concentration additive solution causes less shear degradation and that dense spacing of the additive molecules tends to protect the additive molecules from rupturing. The separate conduit and flow control device for the additive solution makes it furthermore possible to inject either water or additive containing enhanced oil recovery formulation into the formation via the same conduit. This allows injection of water if a well faces a problem with injection of enhanced oil recovery additive or if the addition of additive is not required for example if the part of the formation in question receives additive from a different part of the formation. It also is possible to tailor the additive concentration to suit each well. The use of a single conduit has the additional advantage that less maintenance is required such as reduced pigging and reduced control of the pipeline integrity. Additionally, less storage space is required on vessel 230. A mixture of water, oil and optionally gas can be recovered from the formation via conduits 22, 23, 24, 25, 26 and 27.

1. A process of recovering oil from an oil-bearing formation which process comprises injecting into the formation an aqueous enhanced oil recovery formulation comprising water and an enhanced oil recovery additive, which process comprises
(i) supplying water via a first conduit to a flow control valve,
(ii) combining water which has passed the flow control device with an additive solution containing at least 3000 parts per million by weight (ppm) of the enhanced oil recovery additive to obtain the aqueous enhanced oil recovery formulation,
(iii) injecting the aqueous enhanced oil recovery formulation into the formation via a first well,
(iv) producing from the formation via a second well a mixture comprising water and oil, and
(v) separating oil from the mixture produced.

2. The process according to claim 1, in which the additive is enhanced oil recovery polymer.

3. The process according to claim 2, in which the enhanced oil recovery polymer is selected from the group consisting of partially hydrolyzed polyacrylamide, copolymer of acrylamide and acrylate, copolymer of acrylamide and acrylamido tertiary butyl sulfonate, terpolymer of acrylamide, acrylate and acrylamido tertiary butyl sulfonate and mixtures thereof.

4. The process according to claim 3, in which the enhanced oil recovery polymer is partially hydrolyzed polyacrylamide.

5. The process according to claim 1, in which the additive solution comprises of from 5,000 to 100,000 ppm of enhanced oil recovery additive.

6. The process according to claim 1, in which the concentration of enhanced oil recovery additive in the aqueous enhanced oil recovery formulation is at most 50% of the additive concentration in the additive solution.

7. The process according to claim 1, in which the water has a total dissolved solids (TDS) content of from 1500 to 200,000 ppm.

8. The process according to claim 1, in which the formation is below a body of water.

9. The process according to claim 1, in which additive solution is supplied via multiple conduits each containing an additive flow control device wherein water is added upstream of the additive flow control device and additive is added downstream of the additive flow control device.

10. A system for recovering oil from an oil-bearing formation which system comprises
(a) a first conduit for supplying water to a flow control device which first conduit is in fluid communication with the high pressure side of the flow control device,
(b) a flow control device,
(c) a second conduit which is in fluid communication with the low pressure side of the flow control device and with a first well which first well is in fluid communication with the second conduit and the formation,
(d) a third conduit for supplying an additive solution containing at least 3000 ppm of enhanced oil recovery additive which third conduit is in fluid communication with an additive solution supply and the second conduit,
(e) a second well which is in fluid communication with the formation and a container for collecting the mixture comprising water and oil from the formation, and
(f) a means for separating oil from the mixture comprising water and oil obtained from the formation.
